(19) United States
(12) Patent Application Publication
(10) Pub. No.: US 2014/0192562 A1
(43) Pub. Date: Jul. 10, 2014

(54) SINGLE STAGE AC/DC CONVERTER

(71) Applicants: JEONJU UNIVERSITY OFFICE OF INDUSTRY UNIVERSITY CORPORATION, Jeonju-si (KR); LG INNOTEK CO., LTD, Seoul (KR)

(72) Inventors: Shin CHO, Seoul (KR); Young Soo LEE, Seoul (KR); Eun Soo KIM, Jeonju-si (KR)

(73) Assignees: JEONJU UNIVERSITY OFFICE OF INDUSTRY UNIVERSITY COOPERATION, Jeonju-si (KR); LG INNOTEK CO., LTD, Seoul (KR)

(21) Appl. No.: 14/151,877

(22) Filed: Jan. 10, 2014

(30) Foreign Application Priority Data
Jan. 10, 2013 (KR) 10-2013-0003037

(51) Int. Cl. H02M 7/04

(52) U.S. Cl. CPC H02M 7/04
USPC 363/21.12

(57) ABSTRACT

A single stage AC/DC converter includes a rectifier to rectify an input AC voltage and output the input AC voltage from first and second input nodes to first and second output nodes, an input capacitor connected between the first and second output nodes to store a rectified voltage and output a constant voltage, a transformer unit to transform the voltage received from the input capacitor, and transmit the voltage to a secondary side, and a power factor correction circuit to correct a power factor of a circuit. The power factor correction circuit includes a first auxiliary diode having one terminal connected with the first input node, a second auxiliary diode having one terminal connected with the second input node, and an auxiliary winding inductor connected among opposite terminals of the first and second auxiliary diodes and the first output node or the second output node.

### BACKGROUND

The embodiment relates to a power converter. More particularly, the embodiment relates to a single stage AC/DC converter representing high efficiency.

Generally, in an AC/DC power converter, a simple rectifying unit including an LC filter 10, a diode rectifier 20, and an input capacitor Cᵢₙ is used as an input power source unit in a typical power supply as shown in FIG. 1. In this case, although the structure of the rectifying unit may be simplified, since a harmonic current is included in an AC input power supply current as shown in FIG. 2, an input power factor characteristic may be degraded. Accordingly, IEC61000-3-2 and IEEE 519 standards have been suggested to suppress the harmonic current that may be generated from the power supply.

Recently, in order to solve a problem related to the input power factor characteristic, a power supply employing an input power factor correction circuit to suppress the harmonic current has been used as a lower-power power supply for a laptop adaptor, an LED lighting device, or a display device according to the restriction of the IEC61000-3-2 and IEEE 519 standards as shown in FIG. 3.

A two-stage power supply including a power factor correction (PFC) AC/DC converter 40, which is an input power factor correction circuit to correct the input power factor and a low total harmonic distortion, and a DC/DC converter 50, which is insulated to control an output voltage, is applied to the circuit shown in FIG. 3 to correct the input power factor. However, as the power supply is configured in two stages, components are increased, and limitations exist in efficiency improvement and high-integration.

Therefore, instead of manufacturing the two-stage power supply by using the PFC AC/DC converter 40 to correct the input power factor and the DC/DC converter 50 for insulation, a recent trend is to apply a power supply including a single stage AC/DC converter for the high-power factor in order to reduce cost and accomplish high integration and high efficiency.

Meanwhile, U.S. Pat. No. 6,751,104 B2, which is a related art, discloses a single stage AC/DC converter as shown in FIG. 4. According to the related art, since a rectified current flows through diodes D_{b1} and D_{b2} at the rear end of a rectifier as well as a diode of the rectifier for the operation, a conduction loss may be increased, so that efficiency may be degraded.

Accordingly, a single stage AC/DC power converter representing high efficiency, high integration, and a high power factor is necessary.

### SUMMARY

The embodiment provides a power converter representing improved efficiency. More particularly, the embodiment provides a single stage AC/DC power converter representing high integration, high efficiency, and a high power factor.

According to the embodiment, there is provided a single stage AC/DC converter. The single stage AC/DC converter includes a rectifier to rectify an input AC voltage and output the input AC voltage from a first input node and a second input node to a first output node and a second output node, an input capacitor connected between the first and second output nodes to store a rectified voltage and output a constant voltage, a transformer unit to transform the voltage, which is received from the input capacitor, and transmit the voltage to a secondary side, and a power factor correction circuit to correct a power factor of a circuit. The power factor correction circuit includes a first auxiliary diode having one terminal connected with the first input node, a second auxiliary diode having one terminal connected with the second input node, and an auxiliary winding inductor connected among opposite terminals of the first and second auxiliary diodes and the first output node or the second output node.

As described above, according to the embodiment, a single stage power factor correction circuit can be realized.

According to the embodiment, the input power factor and the harmonic distortion resulting from the reduction of the harmonic current can be improved by using the auxiliary unit.

According to the embodiment, a novel main circuit scheme representing an improved path is suggested so that a conduction loss can be reduced.

According to the embodiment, high integration is possible and the production cost can be reduced by realizing the single stage AC/DC converter.

According to the embodiment, power conversion representing high efficiency is possible.

### BRIEF DESCRIPTION OF THE DRAWINGS

FIG. 1 is a circuit diagram showing an AC/DC power converter according to the related art.

FIG. 2 is a waveform diagram showing an input voltage and an input current in the circuit of FIG. 1.

FIG. 3 is a circuit diagram showing a two-stage AC/DC power converter including a PFC circuit according to the related art.

FIG. 4 is a circuit diagram showing a single stage AC/DC power converter according to the related art.

FIG. 5 is a block diagram showing an AC/DC converter according to one embodiment.

FIG. 6 is a circuit diagram showing an AC/DC converter according to one embodiment.

FIG. 7 is a waveform diagram showing an input voltage and an input current in the circuit of FIG. 6.

FIGS. 8A to 8D are circuit diagrams showing a positive input voltage operating mode in the circuit of FIG. 6.

FIG. 9 is a waveform diagram showing the operation of each unit in the circuit of FIGS. 8A to 8D.

FIG. 10 is a circuit diagram showing an AC/DC converter according to another embodiment.

FIGS. 11A to 11D are circuit diagrams showing a positive input voltage operating mode in the circuit of FIG. 10.

FIGS. 12 to 18 are circuit diagrams showing various applications of the AC/DC converter.

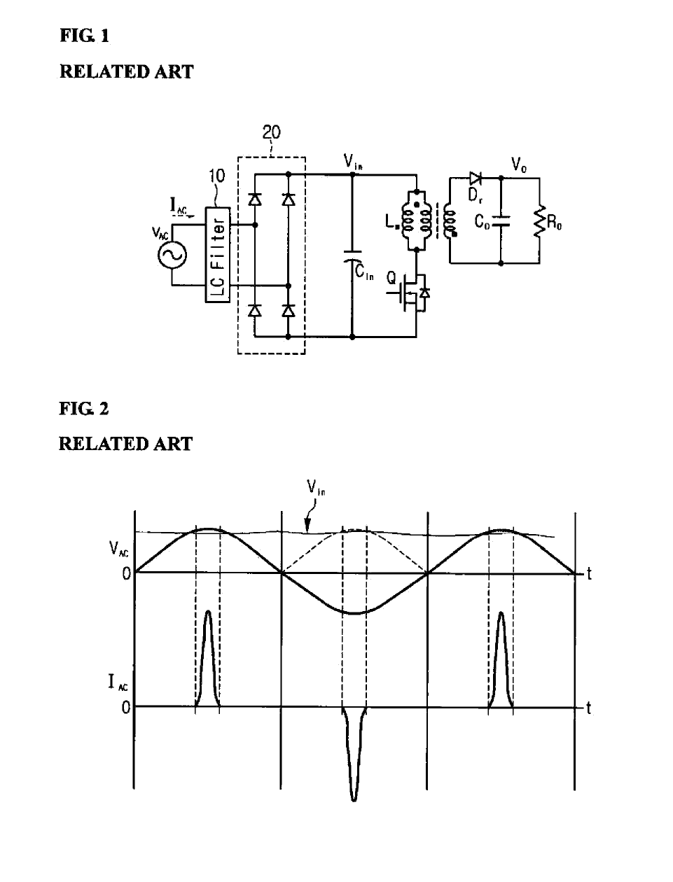

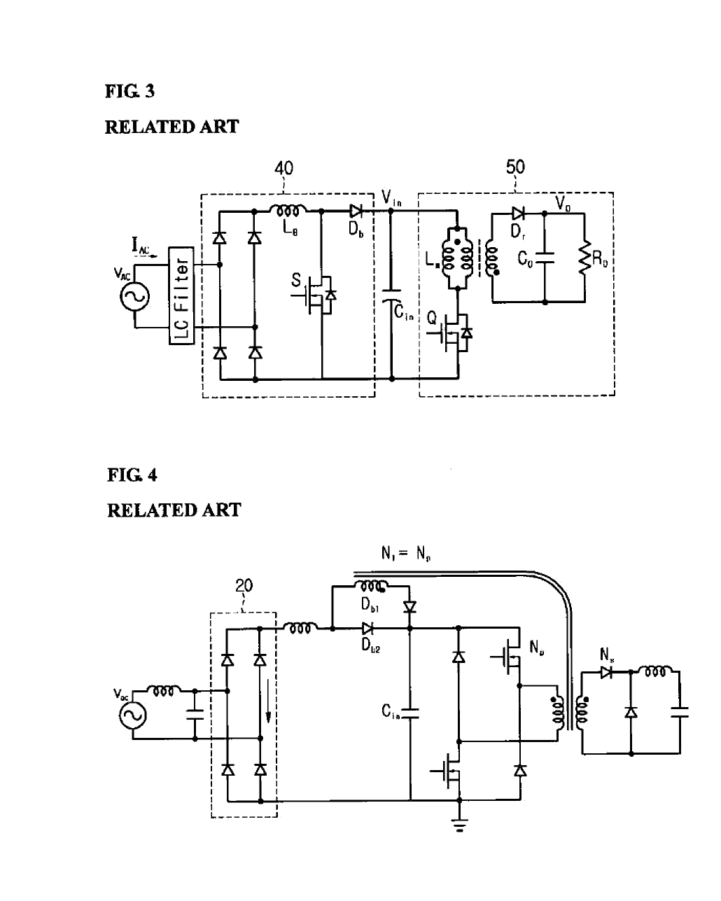

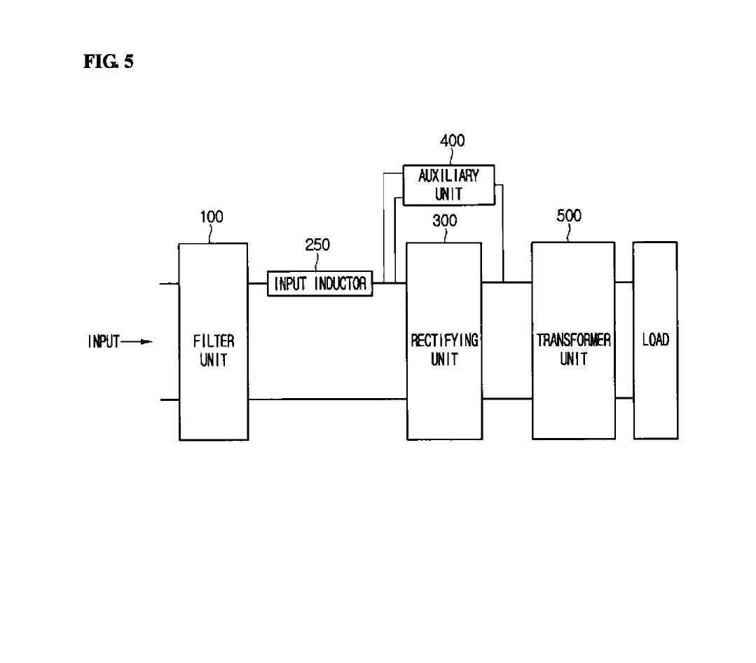

### DETAILED DESCRIPTION OF THE EMBODIMENTS

Hereinafter, embodiments will be described in detail with reference to accompanying drawings so that those skilled in the art can easily work with the embodiments. However, the embodiments may not be limited to those described below, but have various modifications. In addition, only components related to the embodiment are shown in drawings for the clarity of explanation. Hereinafter, the similar reference numerals will be assigned to the similar elements.

In the following description, when a part is connected to the other part, the parts are not only directly connected to each other, but also electrically connected to each other while interposing another part therebetween.

In the following description, when a predetermined part “includes” a predetermined component, the predetermined part does not exclude other components, but may further include other components unless otherwise indicated. In addition, the term “˜part”, “˜device”, or “˜module” refer to a unit to process at least one function or at least operation, and may be implemented in hardware, software, or the combination of the hardware and the software.

Hereinafter, a single stage AC/DC converter according to one embodiment will be described with reference to FIGS. 5 to 9.

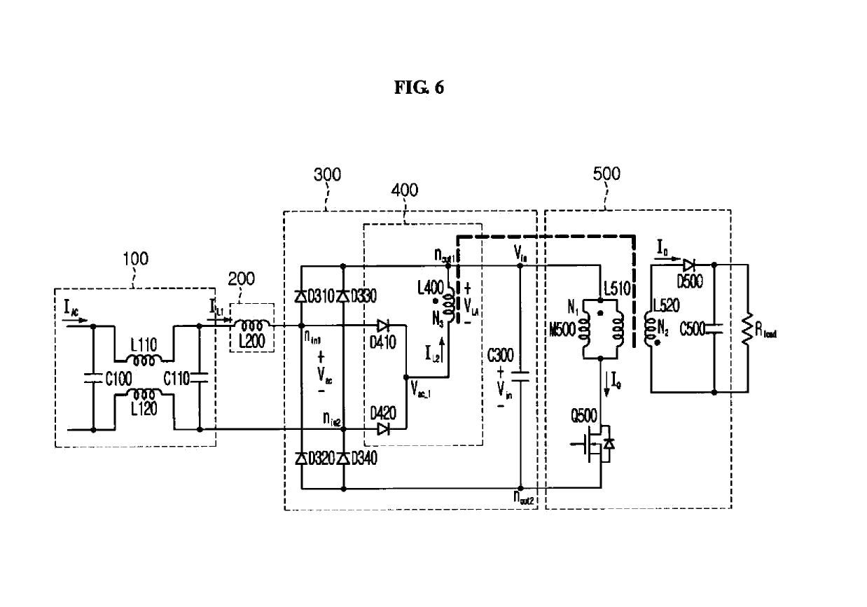

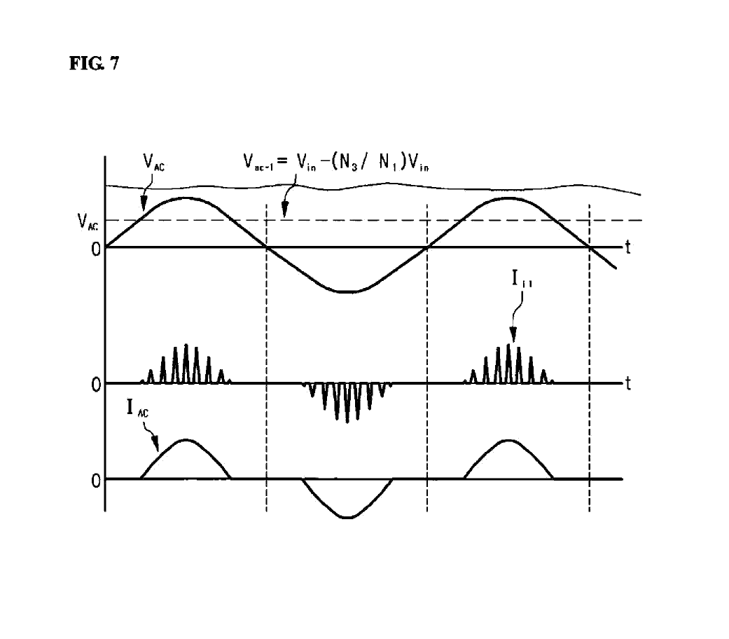

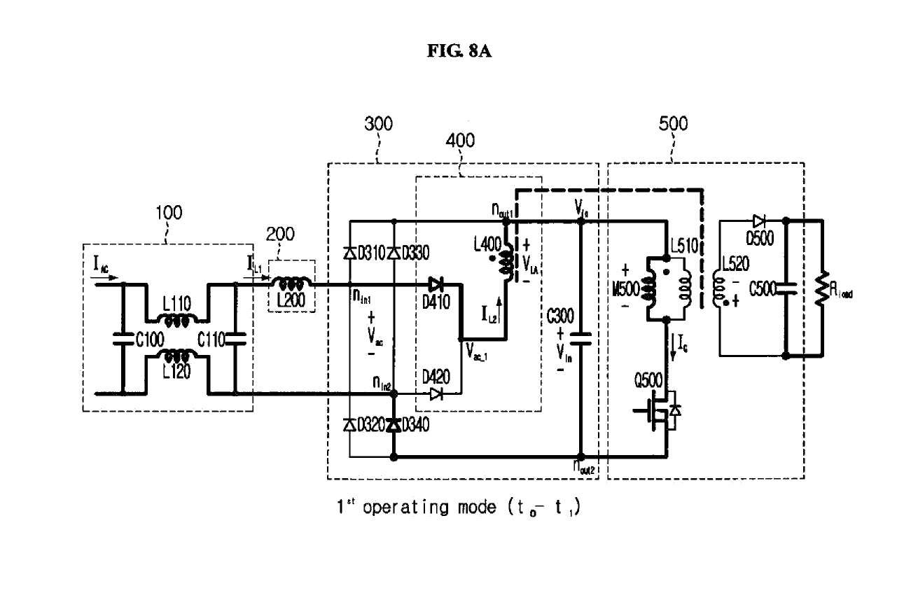

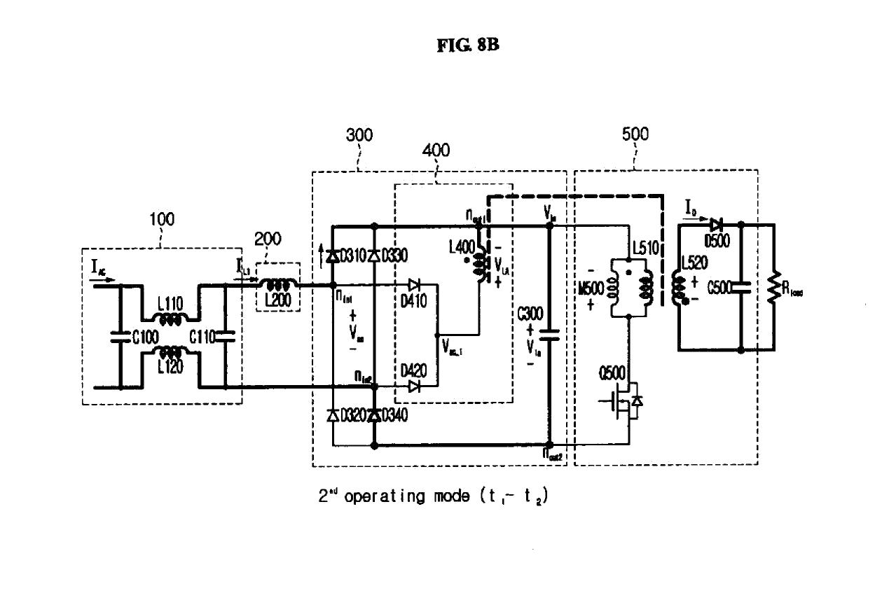

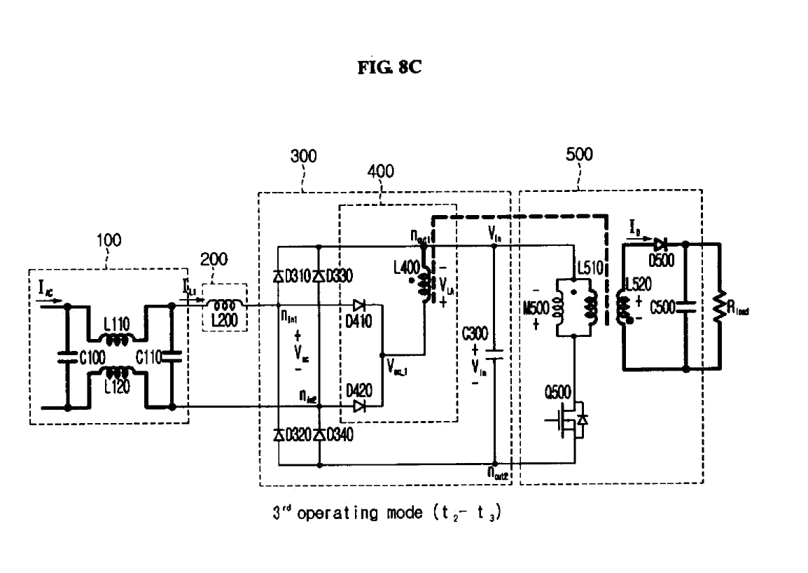

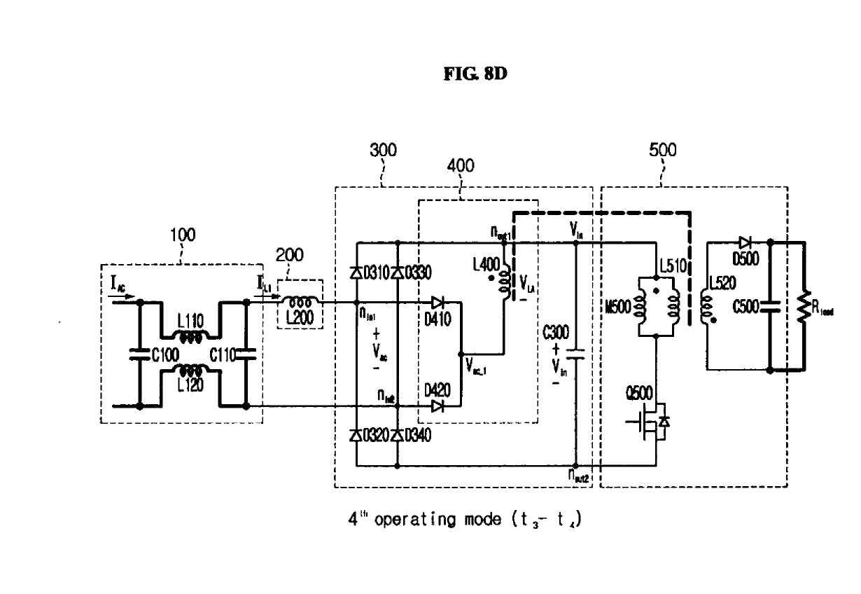

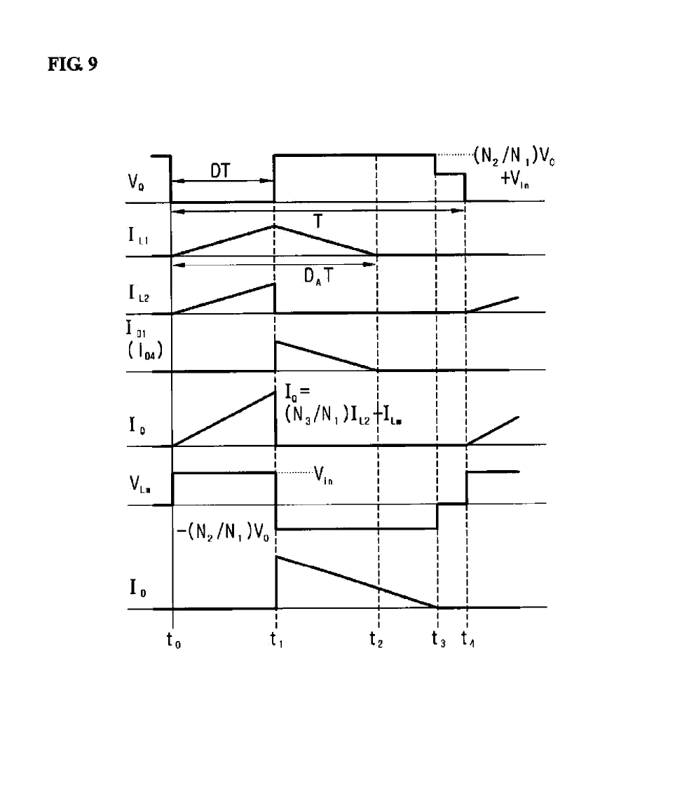

FIG. 5 is a block diagram showing an AC/DC converter according to one embodiment. FIG. 6 is a circuit diagram showing an AC/DC converter according to one embodiment. FIG. 7 is a waveform diagram showing an input voltage and an input current in the circuit of FIG. 6. FIGS. 8A to 8D are circuit diagrams showing a positive input voltage operating mode in the circuit of FIG. 6. FIG. 9 is a waveform diagram showing the operation of each unit in the circuit of FIGS. 8A to 8D.

Referring to FIGS. 5 and 6, the single stage AC/DC converter according to the present invention includes a filter unit 100, an input inductor unit 200, a rectifying unit 300, an auxiliary unit 400, and a transformer unit 500.

The filter unit 100 removes noise, which is input together with an input AC signal, from the input AC signal and outputs the input AC signal to the input inductor unit 200.

The rectifying unit 300 converts an output AC signal from the filter unit 100 into a DC signal to be output to the transformer unit 500.

The auxiliary unit 400 improves an input power factor and harmonic distortion according to the reduction of a harmonic current from an output AC signal of the rectifying unit 300.

The transformer unit 500 transforms the converted DC signal subject to the power factor correction into a signal having a predetermined magnitude and supplies the signal having the predetermined magnitude to a load.

Hereinafter, a power converter according to one embodiment will be described in more detail with reference to FIG. 6. The filter unit 100 may be realized by connecting inductors and capacitors with each other in series/parallel. According to one embodiment, the filter unit 100 may include filter capacitors C100 and C110, and filter inductors L110 and L120. The filter unit 100 includes the filter capacitor C100, to which an input signal is applied, the filter inductor L110 connected with one terminal of the filter capacitor C100, the filter inductor L120 connected with an opposite terminal of the filter capacitor C 100, and the filter capacitor C110 having both terminals connected with opposite terminals of the filter inductors L110 and L120.

The configuration of the filter unit 100 is not limited thereto, but may have various configurations to filter an input AC signal.

An input inductor L200 may be connected between an upper terminal of an output port of the filter unit 100 and a first input node nin1, or connected between a lower terminal of the output port of the filter unit 100 and a second input node nin2.

Accordingly, one terminal of the input inductor L200 is connected with the output port of the filter unit 100, and an opposite terminal of the input terminal L200 is connected with the first input node nin1 of the rectifying unit 300. In more detail, the one terminal of the input inductor L200 is connected with an output terminal of the filter inductor L110, and the opposite terminal of the input inductor L200 is connected with a first diode D310 in a forward direction at the first input node.

Alternately, according to another embodiment, the one terminal of the input inductor L200 may be connected with the output terminal of the filter unit 100, and the opposite terminal of the input inductor L200 may be connected with the second input node nin2 of the rectifying unit 300.

The rectifying unit 300 includes a bridge rectifier and a capacitor. The bridge rectifier may be realized by connecting a plurality of diodes in series/parallel. For example, the rectifying unit 300 includes four diodes that are bridge-connected with each other, and an AC input signal, which has passed through the bridge rectifier, is converted into an AC signal inverted in the same direction. The inverted AC signal is charged in the input capacitor C300 so that a DC voltage having a predetermined size is output to the transformer unit 500.

In more detail, the bridge rectifier includes the first diode D310, a second diode D320, a third diode D330, and a fourth diode D340.

The first diode D310 is connected between a first input node and a first output node in a forward direction, the second diode D320 is connected between the first input node and a second output node in a reverse direction, the third diode D330 is connected between a second input node and the first output node in the forward direction, and the fourth diode D340 is connected between the second input node and the second output node in the reverse direction.

The auxiliary unit 400 includes an auxiliary winding inductor L400 coupled with the transformer unit 500 and two auxiliary diodes D410 and D420 connected with the auxiliary winding inductor L400. The first auxiliary diode D410 is connected with the first input node nin1 in the forward direction, and the second auxiliary diode D420 is connected with the second input node nin2 in the reverse direction.

Cathodes of the first and second auxiliary diodes D410 and D420, which are connected with each other, are connected with one terminal of the auxiliary winding inductor L400 coupled with the transformer unit 500.

An opposite terminal of the auxiliary winding inductor L400, which is coupled with the transformer unit 500, is connected with one terminal of the input capacitor C300 and the transformer unit 500, that is, the first output node nout1.

The transformer unit 500 transforms an input voltage into a voltage having a predetermined size and transmits the voltage having the predetermined size to the load. The transformer unit 500 may include a flyback converter according to one embodiment.

The flyback converter includes a transformer unit-primary winding L510 and a switching device Q500 connected with one terminal of the transformer unit-primary winding L510. The switching device Q500 may include a power MOSFET, or may have a configuration in which a plurality of power MOSFETs are connected with in series/parallel. A secondary configuration of the transformer unit 500 includes a transformer unit-secondary winding L520 magnetic-coupled with the transformer unit-primary winding L510, a diode D500 connected with one terminal of the transformer unit-secondary winding L520 in the forward direction, and an output capacitor C500 having one terminal connected with an opposite terminal of the diode D500 in the reverse direction and an opposite terminal connected with an opposite terminal of the transformer unit-secondary winding L520.

Hereinafter, the variation of the input current according to the variation of the input voltage in the circuit of FIG. 6 will be described with reference to FIG. 7.

V_{AC} is an AC input voltage, V_{ac-1} is a voltage applied to the cathodes of the auxiliary diodes D410 and D420, Vᵢₙ is a voltage applied to the input capacitor C300, V_{LA} is a voltage applied across the auxiliary winding inductor L400 coupled with the transformer unit 500, I_{AC} is an input current, and I_{L1} is a current of the input inductor L200.

In the state that the switching device Q500 is turned on, if the magnitude of V_{AC} is greater than the magnitude of V_{ac-1}, a current may flow through the input inductor L200, and a current may be supplied to the transformer unit 500 for the power transformation.

According to the embodiment, since the magnitude of V_{ac-1} is reduced by the voltage applied across the auxiliary winding inductor L400 coupled with the transformer unit 500, the duration, in which the magnitude of V_{AC} is greater than the magnitude of V_{ac-1}, is increased, so that the durations, in which I_{L1} and L_{AC} are generated, are increased. Accordingly, the phase difference between the input voltage and the input current is reduced, so that the power factor is corrected.

When comparing with the related art shown in FIG. 2, since the magnitude of Vᵢₙ has a greater value in FIG. 2, the duration in which the magnitude of V_{AC} is greater than the magnitude of Vᵢₙ is shorter. Therefore, the duration in which I_{AC} is generated is shorter, so that the phase difference between the input voltage and the input current is increased, and the superior power factor is not represented. According to the embodiment, since a current can flow through the input inductor L100 even at a low input voltage by the auxiliary winding inductor L400 coupled with the transformer unit 500, so that the power factor can be corrected.

Hereinafter, the operation of a circuit according to a switching operation if a positive AC voltage is input will be described with reference to FIGS. 8 and 9.

Regarding each duration, a duration of t0 to t1 is a duration in which the switching device Q500 is turned on, and a duration of t1 to t4 is a duration in which the switching device Q500 is turned off.

The turn-off duration may be divided as follows. The duration of t1 to t2 is a duration in which energy stored in the input inductor L100 at the duration of t0 to t1 is reset, a duration of t1 to t3 is a duration in which the energy stored in the magnetic inductor M500 of the transformer unit 500 is transmitted to the transformer unit-secondary winding L520, and a duration of t3 to t4 is a duration in which energy is not delivered to the secondary side from the primary side, but the energy stored in the output capacitor C500 at the secondary side is reset.

First, the duration of t0 and t1 will be described below.

A first operating mode (duration of t0 to t1) will be described with reference to FIG. 8A below. If the switching device Q500 is turned on, the auxiliary winding inductor L400 coupled with the transformer unit 500 is connected to the input capacitor C300 together with the input power source through the input inductor L200, the auxiliary diode D410, and the fourth diode D340 of the bridge rectifier. In addition, energy is stored in the magnetic inductor M500 of the transformer unit 500.

In more detail, if the switching device Q500 is turned on, an input inductor-current I_{L1} flowing through the input inductor L200 is constantly raised. In addition, an auxiliary winding inductor-current I_{L2} flowing through the auxiliary winding inductor L400 coupled with the transformer unit 500 is constantly raised together with the inductor-current I_{L1}.

In other words, the first diode D310 of the bridge rectifier is reverse-biased, so that a current does not flow through the first diode D310 of the bridge rectifier, but the first auxiliary diode D410 of the auxiliary unit 400 is forward-biased, so that the input inductor-current I_{L1} is identical to the auxiliary winding inductor-current I_{L2}.

The input capacitor-voltage Vᵢₙ is constantly maintained, and the switching device Q500 is turned on, so that voltage having the same magnitude as that of the input capacitor voltage Vᵢₙ is applied across both terminals of the magnetic inductor M500 of the transformer unit 500. The current flowing through the switching device Q500 is the sum of the current I_{Lm} flowing through the magnetic inductor M500 of the transformer unit 500 and the current flowing through the auxiliary winding inductor L400 coupled with the transformer unit 500, which is induced to the primary side of the transformer unit 500, and constantly raised.

The secondary side of the transformer unit 500 is in an open state because the diode D500 at the secondary side is reverse-biased. Accordingly, an induced current does not flow through the secondary side of the transformer unit 500.

Next, if the switching device Q500 is turned off, the voltage polarity of the auxiliary winding inductor L400 coupled with the transformer unit 500 is changed. Accordingly, the auxiliary diodes D410 and D420 are reverse-biased, so that a current does not flow through the auxiliary diodes D410 and D420.

In addition, if the switching device Q500 is turned off, a reverse voltage is applied to the magnetic inductor M500 of the transformer unit 500, so that the secondary side of the transformer unit 500 is forward-biased. Accordingly, the induced current flows through the transformer unit-secondary winding L520.

Hereinafter, a second operating mode (duration of t1 to t2) will be described with reference to FIG. 8B. The auxiliary diodes D410 and D420 are reverse-biased, so that a current does not flow through the auxiliary diodes D410 and D420, but the energy stored in the input inductor L200 at the turn-on duration of the switching device flows through the first diode D310 of the bridge rectifier and the input capacitor C300 is reset. At the moment when the switching device Q500 is turned off, a constant reverse voltage is applied to the magnetic inductor M500 of the transformer unit 500. Accordingly, the energy stored in the magnetic inductor M500 of the transformer unit 500 during the turn-on duration of the switching device is transmitted to the output capacitor C500 through the diode D500 at the secondary side of the transformer unit 500. The magnitude of a secondary-side diode current ID is reduced.

Hereinafter, a third operating mode (duration of t2 to t3) will be described with reference to FIG. 8C. The energy stored in the input inductor L200 is completely consumed at a previous step, so that currents do not flow through the input inductor L200 and the first diode D310 of the bridge rectifier. Meanwhile, since energy remains in the magnetic inductor M500 of the transformer unit 500, the energy stored in the magnetic inductor M500 of the transformer unit 500 is transmitted to the output capacitor C500 through the diode D500 at the secondary side of the transformer unit 500 similarly to the duration of t1 to t3, and the magnitude of the secondary-side diode current ID is steadily reduced.

Finally, a fourth operating mode (duration of t3 to t4) will be described with reference to FIG. 8D. If all energy stored in the magnetic inductor M500 of the transformer unit 500 is transmitted to the transformer unit-secondary winding L520, the voltage V_{Lm} of the magnetic inductor M500 of the transformer unit 500 becomes 0, and a voltage V_{Q} having a magnitude, which is reduced by the magnitude of the voltage applied to the magnetic inductor M500 of the transformer unit 500 at a previous step, is applied to the switching device. In addition, the energy is not transmitted from the primary side to the secondary side of the transformer unit 500, and the diode D500 at the secondary side is reverse-biased, so that a current does not flow, and the energy stored in the output capacitor C500 is transmitted to the load and reset.

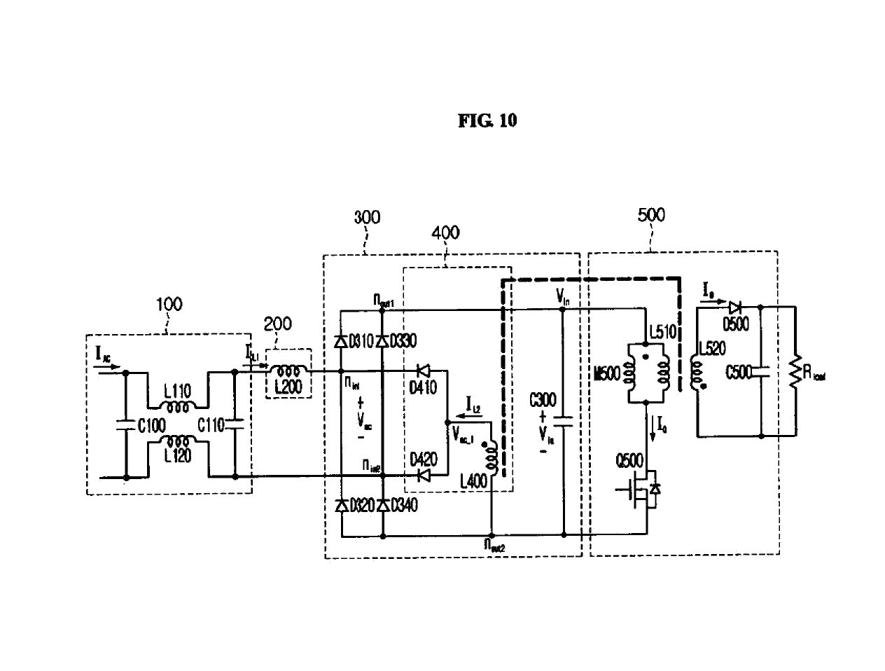

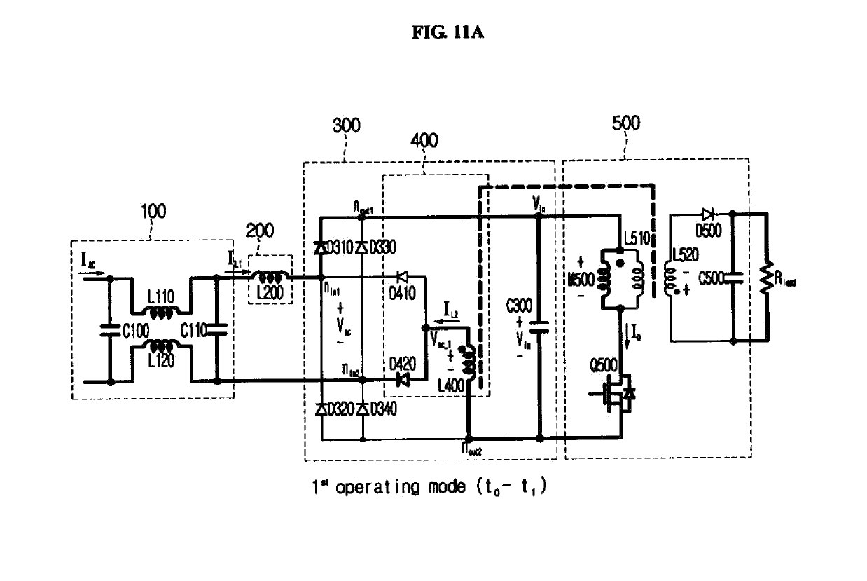

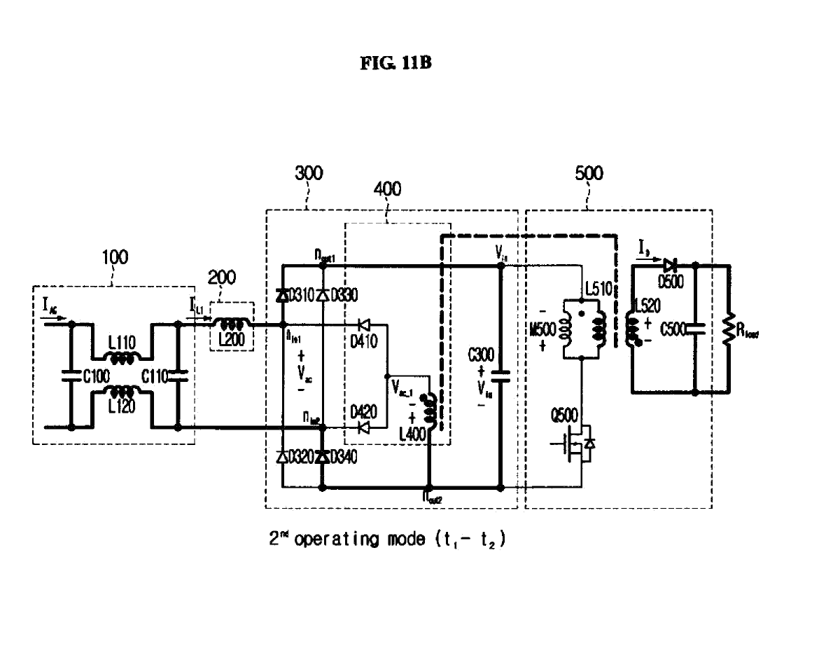

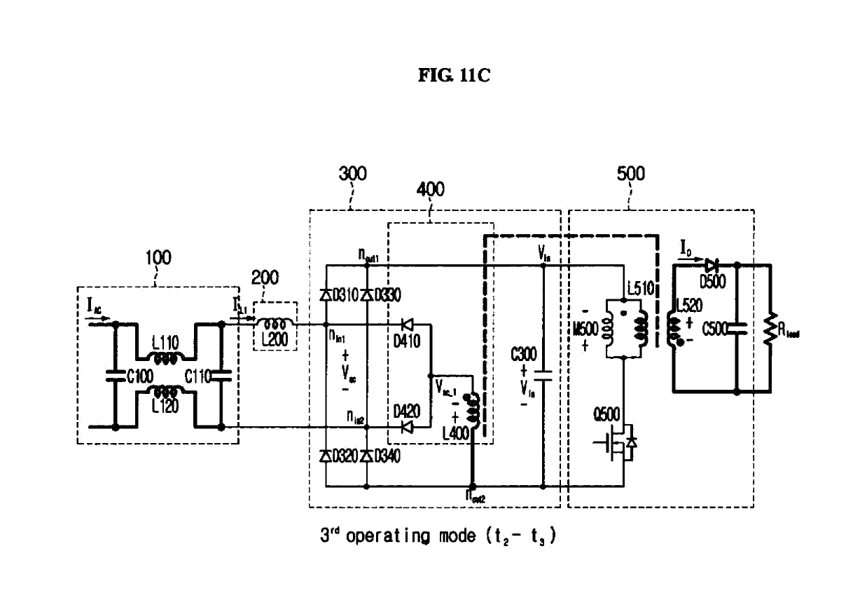

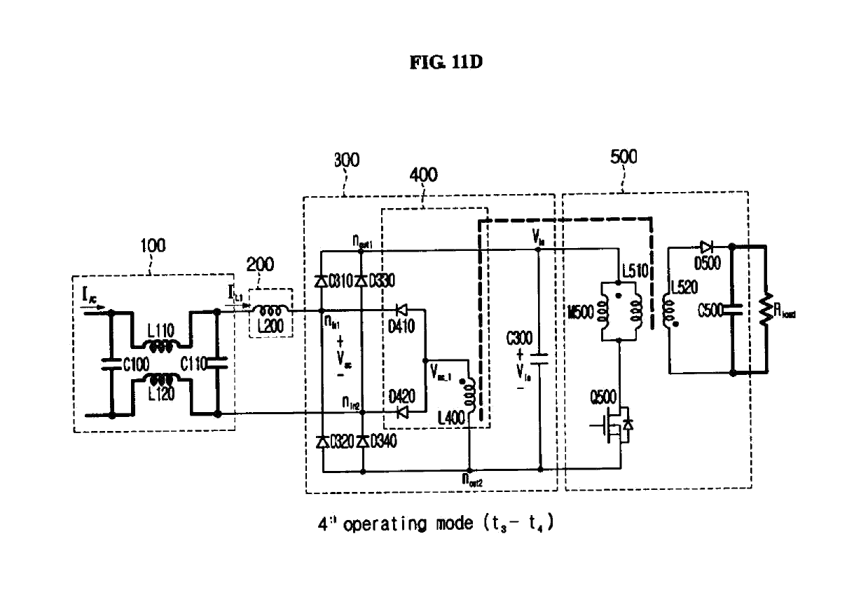

Hereinafter, another embodiment will be described with reference to FIGS. 10 to 11D.

FIG. 10 is a circuit diagram showing an AC/DC converter according to another embodiment, and FIGS. 11A to 11D are circuit diagrams showing a positive input voltage operating mode in the circuit of FIG. 10.

Referring to FIG. 10, a single stage AC/DC converter of FIG. 10 makes a difference from the AC/DC converter of FIG. 6 in the connection relationship of the auxiliary unit 400. In other words, the single stage AC/DC converter of FIG. 10 makes a difference from the AC/DC converter of FIG. 6 in the connection directions of the auxiliary diodes D410 and D420, the connection of the auxiliary winding inductor L400 coupled with the transformer unit 500, and the connection relationship between the auxiliary winding inductor L400 coupled with the transformer unit 500 and the input capacitor C300.

In more detail, one terminal of the first and second auxiliary diodes D410 and D420 are connected with the filter unit 100 in a reverse direction, and opposite terminals of the first and second auxiliary diodes D410 and D420 are connected with one terminal of the auxiliary winding inductor L400 coupled with the transformer unit 500. In addition, an opposite terminal of the auxiliary winding inductor L400 is connected with one terminal of the input capacitor C300 and the switching device Q500.

Hereinafter, description will be made regarding a circuit operation according to a switching operation if a positive AC voltage is input.

Operation durations according to the switching operation are divided in the same manner as the operation durations described with reference to FIGS. 8 and 9 are divided.

First, the first operating mode (duration of t0 to t1) will be described with reference to FIG. 11A below. If the switching device Q500 is turned on, the auxiliary winding inductor L400 coupled with the transformer unit 500 is connected to the input capacitor C300 together with the input power source through the input inductor L200, the auxiliary diode D420, and the first diode D340 of the bridge rectifier. In addition, energy is stored in the magnetic inductor M500 of the transformer unit 500.

Next, if the switching device Q500 is turned off, the voltage polarity of the auxiliary winding inductor L400 coupled with the transformer unit 500 is changed. Accordingly, the auxiliary diodes D410 and D420 are reverse-biased, so that a current does not flow through the auxiliary diodes D410 and D420. In addition, if the switching device Q500 is turned off, a reverse voltage is applied to the magnetic inductor M500 of the transformer unit 500, so that the secondary side of the transformer unit 500 is forward-biased. Accordingly, the induced current flows through the transformer unit-secondary winding L520.

The operations at the second operating mode (duration of t1 and t2), the third operating mode (t2 and t3), and the fourth operating mode (duration of t3 and t4) have the same as operations when the switching device Q500 is turned, off in FIGS. 8 and 9 (see FIGS. 11B, 11C, and 11D).

Therefore, the operation waveform of each unit according to the present embodiment is the same as the operation waveform of each unit of FIG. 9.

The insulating effect between the auxiliary winding inductor L400 and the transformer unit 500 can be improved by connecting an opposite terminal of the auxiliary winding inductor L400 to one terminal of the input capacitor C300 and one terminal of the switching device Q500 differently from FIG. 7 showing the direct connection of the auxiliary winding inductor L400, which is coupled with the transformer unit 500, to the transformer unit 500.

In other words, the magnetic noise phenomenon between the auxiliary winding inductor L400 and the transformer unit 500 can be reduced through the insulating effect of the input capacitor C300 and the insulating effect depending on the threshold voltage of the switching device Q500.

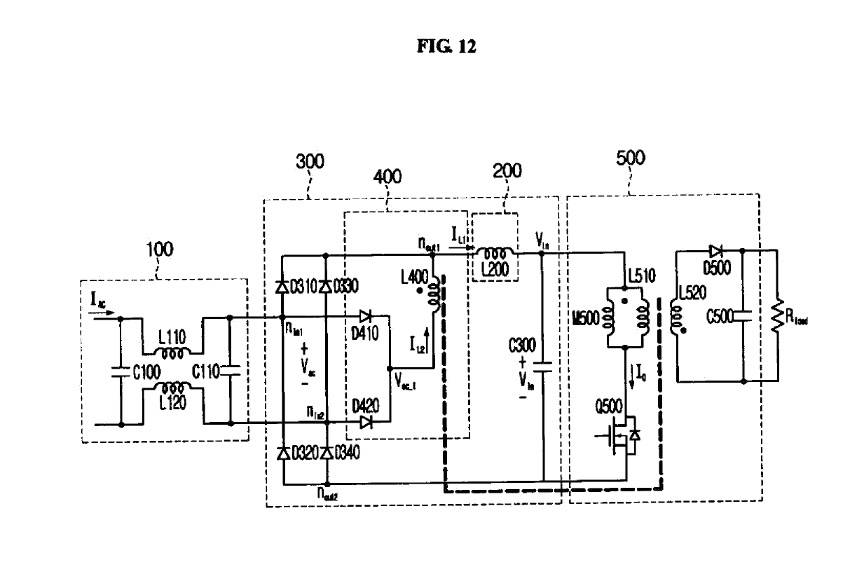

Hereinafter, various applications will be described with reference to FIGS. 12 to 18.

FIGS. 12 to 15 are circuit diagrams showing various applications of the embodiment. The applications are different from each other in the positions and the configuration of the input inductor 200.

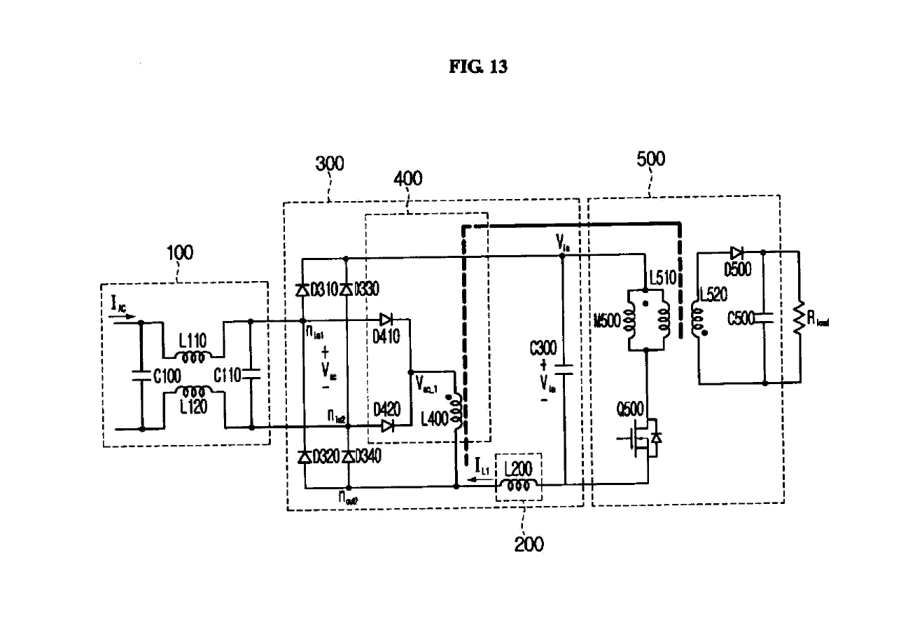

The circuit of FIG. 12 makes a difference from the circuit of FIG. 6 in the position of the input inductor L200, and the circuit of FIG. 13 makes a difference from the circuit of FIG. 10 in the position of the input inductor L200. The position of the input inductor L200 interposed between a rear end of the filter unit 100 and a front end of the diode rectifier (D310, D320, D330, and D340) shown in FIGS. 6 and 10 is changed to a position between a rear end of the diode rectifier (D310, D320, D330, and D340) and the input capacitor C300 shown in FIGS. 12 and 13.

When the position of the input inductor L200 is differently changed as shown in FIGS. 12 and 13, energy stored in the input inductor L200 can be rapidly reduced.

In order to prevent the discharge delay of energy stored in the input inductor L200 occurring according to the threshold voltage of the first diode D310, the input inductor L200 is directly connected to the input capacitor C300.

In other words, as described with reference to FIG. 8B, at the second operating mode (duration of t1 to t2), the energy stored in the input inductor L200 directly flows through the input capacitor C300 without passing through the first diode D310 of the bridge rectifier, so that reset can be rapidly performed.

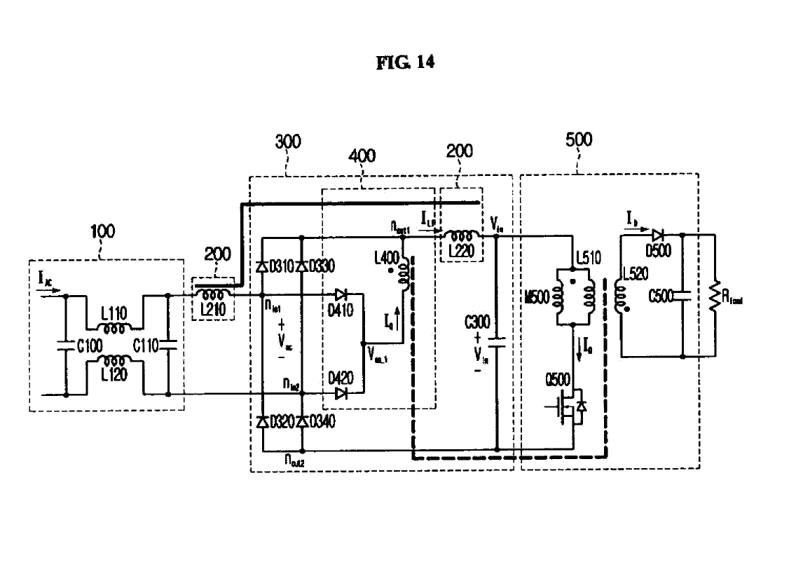

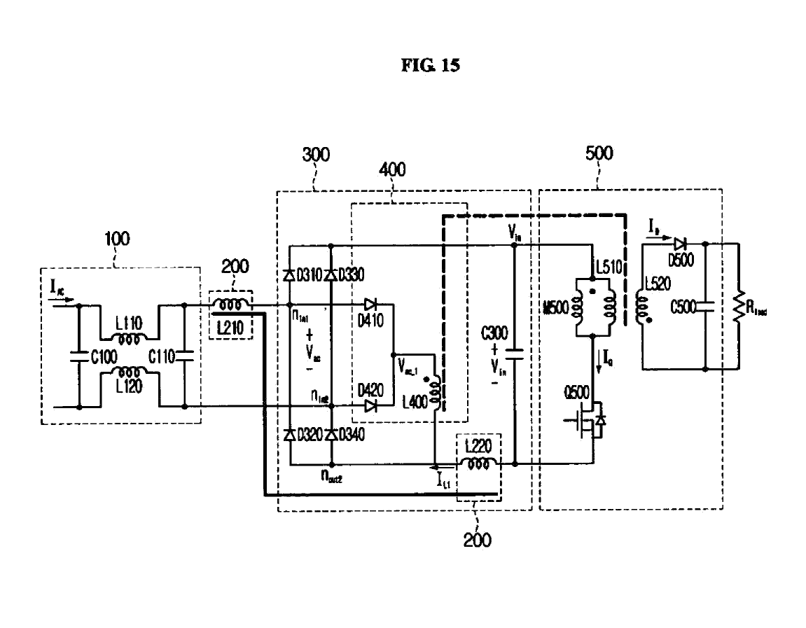

FIGS. 14 and 15 are circuit diagrams according to still another embodiment realized by constructing the input inductor L200 with coupling inductors L210 and L220.

In other words, according to the previous embodiment, the input inductor L200 is connected between the rear end of the filter unit 100 and the front end of the diode rectifier (D310, D320, D330, and D340) or connected between the rear end of the diode rectifier (D310, D320, D330, and D340) and the input capacitor C300.

The embodiment of FIGS. 14 and 15 shows a configuration with the first and second input inductors L210 and L220. The first input inductor L210 is connected between the rear end of the filter unit 100 and the front end of the diode rectifier (D310, D320, D330, and D340), and the second input inductor L220 is connected between the rear end of the diode rectifier (D310, D320, D330, and D340) and the input capacitor C300. The first input inductor L210 and the second input inductor L220 are variously coupled depending on a turn ratio.

Energy can be transmitted between the first and second input inductors L210 and L220 through the coupling between the first and second input inductors L210 and L220, and the magnetic coupling between the first input inductor L210 and the second input inductor L220. As described above, the energy stored in the first input inductor L210 may be dissipated through two paths formed of a path to the first diode D310 and a path formed through the magnetic coupling with the second input inductor L220. Accordingly, the energy stored in the input first inductor L210 can be rapidly increased.

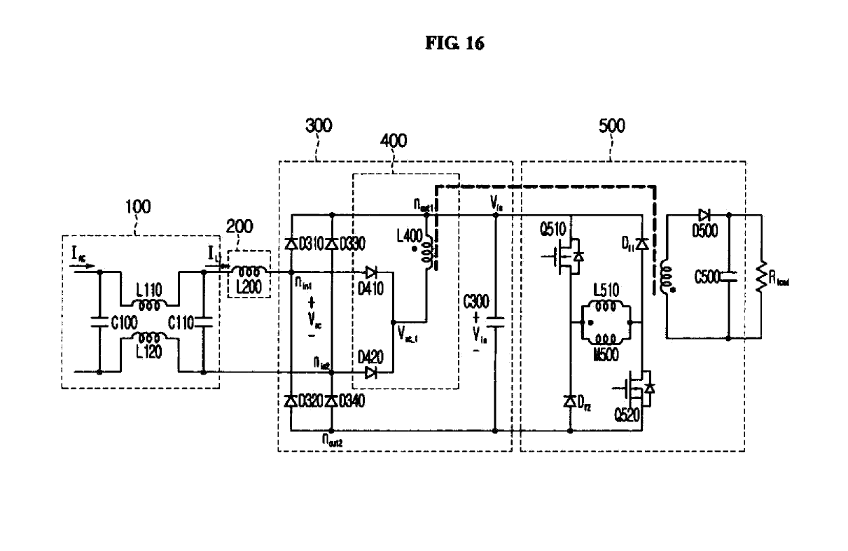

FIG. 16 is a circuit diagram according to still yet another embodiment in which the transformer unit 500 in the circuit of FIG. 6 is realized by using a flyback converter employing two switching devices.

The configuration of the circuit shown in FIG. 16 is the same as that of the circuit shown in FIG. 6 except for the configuration of the transformer unit 500. Regarding one embodiment of the flyback converter employing two switching devices, which makes a difference from that of the circuit shown in FIG. 6, the flyback converter employing two switching devices includes a first switching device Q510, a second switching device Q520, a first diode D_{f1} at the primary side of the transformer unit 500, a second diode D_{f2} at the primary side of the transformer unit 500, the diode D500 at the secondary side of the transformer unit 500, the transformer unit-primary winding L510, the transformer unit-secondary winding L520, and the output capacitor C500.

One terminal of the first switching device Q510 is connected to one terminal of the input capacitor C300 and the first diode D_{f1} at the primary side of the transformer unit 500 in the reverse direction. An opposite terminal of the first switching device Q510 is connected to one terminal of the transformer unit-primary winding L510 and the second diode D_{f2} at the primary of the transformer unit 500. An opposite terminal of the transformer unit-primary winding L510 is connected to one terminal of the second switching device Q520 and the first diode D_{f1} at the primary side in the forward direction. An opposite terminal of the second switching device Q520 is connected to the opposite terminal of the input capacitor C300 and the second diode D_{f2} at the primary side of the transformer unit 500.

The secondary side of the transformer unit 500 includes a transformer unit-secondary winding L520 electrically connected with the transformer unit-primary winding L510, the diode D500 connected with one terminal of the transformer unit-secondary winding L520 in the forward direction, and the capacitor C500 having one terminal connected with the opposite terminal of the diode D500 in the reverse direction and an opposite terminal connected with the opposite terminal of the transformer unit-secondary winding L520.

In addition, although the configuration of the transformer unit 500 shown in FIGS. 10, and 12 to 15 is differently changed to the configuration of the transformer unit 500 having the flyback converter employing two switching devices, the overall operation of the circuit of FIG. 16 have the same operating characteristic as those of the circuits of FIGS. 10, and 12 to 15.

As shown in FIG. 16, when the transformer unit 500 is configured with the two switches, the transformer unit 500 may be more advantageous in a large-capacity topology.

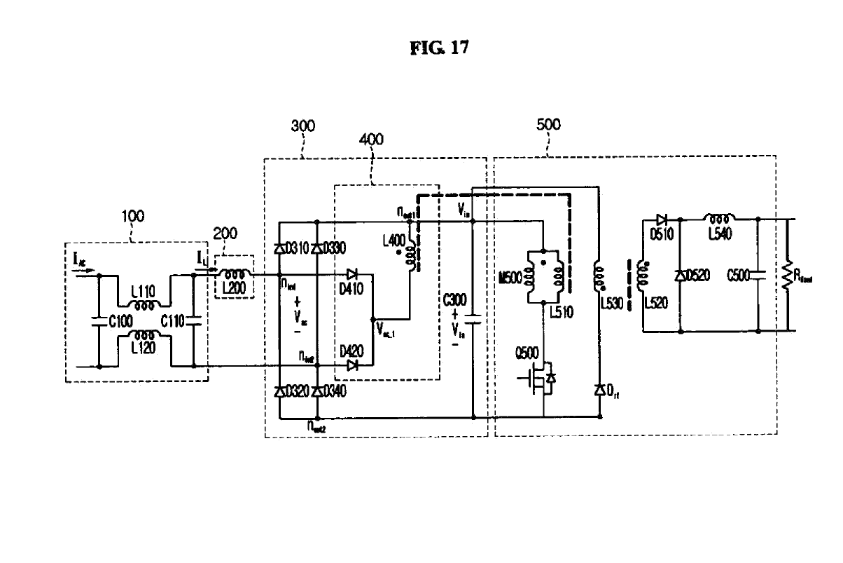

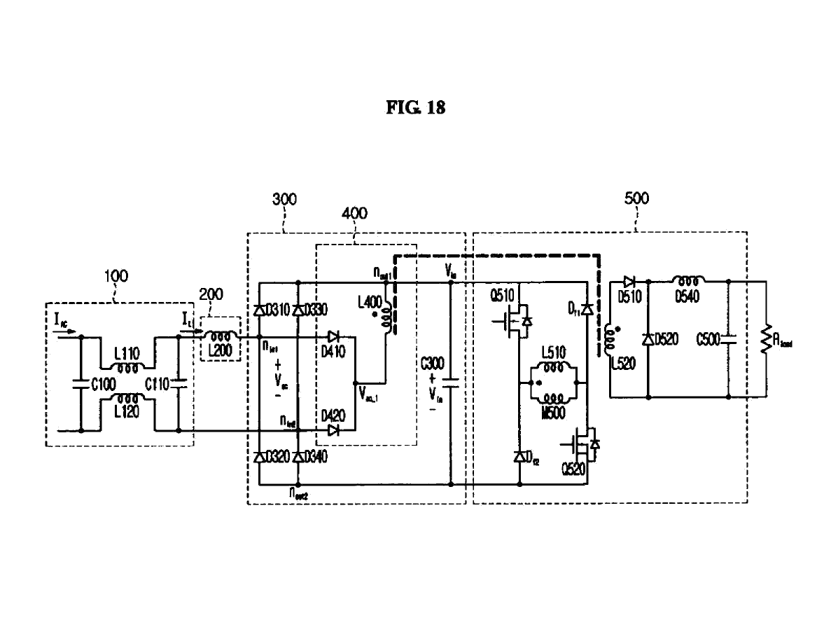

According to stilly yet another embodiment, FIGS. 17 and 18 are circuit diagrams showing a converter including a forward converter.

FIG. 17 shows an AC/DC converter including a forward converter employing one switching device, and FIG. 18 shows an AC/DC converter including a forward converter employing two switching devices.

FIG. 17 shows an AC/DC converter in which a forward converter employing one switching device is applied to the configuration of the transformer unit 500 provided in the circuit of FIG. 6, and FIG. 18 shows a single stage AC/DC converter in which a forward converter employing two switching devices is applied to the configuration of the transformer unit 500 provided in the circuit of FIG. 16.

Regarding the circuit of FIG. 17, the circuit of FIG. 17 is the same as the circuit of FIG. 6 in configuration except for the transformer unit 500. In the configuration of the transformer unit 500 provided in the circuit of FIG. 17, a primary side further includes a reset winding L530 and a reset diode D_{rf}, and a secondary side further includes a secondary-side first diode D510, a secondary-side second diode D520, and an output inductor L540.

In more detail, the reset winding L530 of the transformer unit 500 has one terminal connected with a first output node nₒᵤₜ₁ and an opposite terminal connected with the reset diode D_{rf} in the reverse direction. An opposite terminal of the reset diode D_{rf} is connected with a second output node nₒᵤₜ₂.

The transformer unit-secondary winding L520 is magnetic-coupled with the transformer unit-primary winding L510. One terminal of the secondary side-first diode D510 is connected with the transformer unit-secondary winding L520 in the forward direction, and an opposite terminal of the secondary side-first diode D510 is connected with one terminal of the secondary side-second diode D520 and one terminal of an output inductor L540 in the reverse direction. An opposite terminal of the output inductor L540 is connected with one terminal of the output capacitor C500. In addition, opposite terminals of the transformer unit-secondary winding L520, the secondary side-second diode D520, and the output capacitor C500 are connected with one node.

Although the forward converter is applied to the configuration of the transformer unit 500 as described above, the circuit of FIG. 17 has the same power factor correction characteristic as that of the circuit of FIG. 6.

In addition, although the modification in the connection relationships of the input inductor L200 and the auxiliary unit 400 is applied to the circuit of FIG. 17 similarly to the circuits of FIGS. 10, and 12 to 15, the above circuits can obtain the same result.

Regarding the circuit of FIG. 18, the circuit of FIG. 18 includes a single stage AC/DC forward converter employing two switching devices.

Regarding the configuration of FIG. 18, the circuit of FIG. 18 makes a difference from the circuit of FIG. 16 in the configuration of the secondary side of the transformer unit 500.

Hereinafter, the configuration of the secondary side of the transformer unit 500 will be described. The transformer unit-secondary winding L520 is magnetic-connected with the transformer unit-primary winding L510. One terminal of the secondary-side first diode D510 is connected with the transformer unit-secondary winding L520 in the forward direction, and an opposite terminal of the secondary-side secondary diode D520 is connected with one terminal of the secondary-side second diode D520 and one terminal of the output inductor L540 in the reverse direction. An opposite terminal of the output inductor L540 is connected with one terminal of the output capacitor C500. In addition, opposite terminals of the transformer unit-secondary winding L520, the secondary-side second diode D520, and the output capacitor C500 are connected with one node.

Although the forward converter is applied to the configuration of the transformer unit 500 as described above, the circuit of FIG. 18 has the same power factor correction characteristics as those of the circuit of FIGS. 6, 16, and 17.

In addition, although the modification in the connection relationships of the input inductor L200 and the auxiliary unit 400 is applied to the circuit of FIG. 18 similarly to the circuits of FIGS. 10, and 12 to 15, the above circuits can obtain the same result.

In other words, even if the configuration of the transformer unit 500 is changed to a forward converter type, the configuration of the auxiliary unit 400 and the connection relationship between the auxiliary unit 400 and the input capacitor 0300 are not changed. Accordingly, as shown in FIGS. 6 and 16, since a current may flow through the input inductor L200 depending on a voltage applied to the auxiliary winding inductor L400 coupled with the transformer unit 500 even if a low voltage is applied to the input inductor L200, power factor correction can be achieved.

Meanwhile, the configuration of the transformer unit 500 is not limited to the flyback converter type or the forward converter type, but may be realized by using a DC-DC converter connected with the input capacitor C300.

The above described embodiment is not only implemented only through an apparatus and a method, but also implemented through a program to execute functions corresponding to the components of the embodiment and recording media in which the program is recorded. The above implementation can be easily performed based on the above-described embodiment by one ordinary skilled in the art.

Although the exemplary embodiments have been described, it is understood that the present invention should not be limited to these exemplary embodiments but various changes and modifications can be made by one ordinary skilled in the art within the spirit and scope of the present invention as hereinafter claimed.

What is claimed is:

1. A single stage AC/DC converter comprising:
a rectifier to rectify an input AC voltage and output the input AC voltage from a first input node and a second input node to a first output node and a second output node;
an input capacitor connected between the first and second output nodes to store a rectified voltage and output a constant voltage;
a transformer unit to transform the voltage, which is received from the input capacitor, and transmit the voltage from a primary side to a secondary side; and
a power factor correction circuit to correct a power factor of a circuit,
wherein the power factor correction circuit comprises:
a first auxiliary diode having one terminal connected with the first input node;
a second auxiliary diode having one terminal connected with the second input node;
an auxiliary winding inductor connected between opposite terminals of the first and second auxiliary diodes and the first output node, and coupled with the transformer unit; and
a first input inductor connected between the auxiliary winding inductor connected with the first output node and the input capacitor.

2. The single stage AC/DC converter of claim 1, wherein the auxiliary winding inductor is coupled with a primary winding of the transformer unit.

3. The single stage AC/DC converter of claim 2, wherein the first and second auxiliary diodes are connected with one terminal of the auxiliary winding inductor in a reverse direction, and an opposite terminal of the auxiliary winding inductor is connected with the first output node.

4. The single stage AC/DC converter of claim 1, further comprising a second input inductor connected between the input AC voltage and the first input node.

5. The single stage AC/DC converter of claim 4, wherein the first and second input inductors are coupled with each other.

6. The single stage AC/DC converter of claim 1, further comprising a filter unit connected between the input AC voltage and the first input node to remove noise from the input AC voltage.

7. The single stage AC/DC converter of claim 6, wherein the filter unit comprises first and second filter inductors connected with in parallel, a first filter capacitor connected among one terminal of the first filter inductor, one terminal of the second filter inductor, and a second filter capacitor connected between opposite terminals of the first and second filter inductors.

8. The single stage AC/DC converter of claim 1, wherein the transformer unit comprises a switching device connected between the primary winding and the second output node, and
wherein the secondary side of the transformer unit comprises:
a secondary winding magnetically coupled with the primary winding;
a first output diode connected with one terminal of the secondary winding in a forward direction;
a second output diode connected with the first output diode in a reverse direction; and
an output inductor having one terminal connected with the first and second output diodes in the reverse direction and an opposite terminal connected with an output capacitor.

9. The single stage AC/DC converter of claim 8, wherein the primary side of the transformer unit comprises:
a first switching device and a primary-side first diode having one terminal connected with the first output node; and
a second switching device and a primary-side second diode having one terminal connected with the second output node,
wherein the primary winding has one terminal connected with opposite terminals of the first switching device and the primary-side second diode and an opposite terminal connected with opposite terminals of the second switching device and the primary-side first diode.

10. The single stage AC/DC converter of claim 8, wherein the transformer unit further comprises a reset winding and a diode connected to each other in series between the first and second output nodes, and the reset winding is connected with the diode in a reverse direction.

11. A single stage AC/DC converter comprising:
a rectifier to rectify an input AC voltage and output the input AC voltage from a first input node and a second input node to a first output node and a second output node;
an input capacitor connected between the first and second output nodes to store a rectified voltage and output a constant voltage;
a transformer unit to transform the voltage, which is received from the input capacitor, and transmit the voltage from a primary side to a secondary side; and
a power factor correction circuit to correct a power factor of a circuit,
wherein the power factor correction circuit comprises:
a first auxiliary diode having one terminal connected with the first input node;
a second auxiliary diode having one terminal connected with the second input node;
an auxiliary winding inductor connected among opposite terminals of the first and second auxiliary diodes and the second output node, and coupled with the transformer unit; and
a first input inductor connected between the auxiliary winding inductor connected with the first output node and the input capacitor.

12. The single stage AC/DC converter of claim 11, wherein the auxiliary winding inductor is coupled with a primary winding of the transformer unit.

13. The single stage AC/DC converter of claim 12, wherein the first and second auxiliary diodes are connected with one terminal of the auxiliary winding inductor in a forward direction, and an opposite terminal of the auxiliary winding inductor is connected with the second output node.

14. The single stage AC/DC converter of claim 11, further comprising a second input inductor connected between the input AC voltage and the first input node.

15. The single stage AC/DC converter of claim 14, wherein the first and second input inductors are coupled with each other.

16. The single stage AC/DC converter of claim 11, further comprising a filter unit connected between the input AC voltage and the first input node to remove noise from the input AC voltage.

17. The single stage AC/DC converter of claim 16, wherein the filter unit comprises first and second filter inductors connected with in parallel, a first filter capacitor connected among one, terminal of the first filter inductor, one terminal of the second filter inductor, and a second filter capacitor connected between opposite terminals of the first and second filter inductors.

18. The single stage AC/DC converter of claim 11, wherein the transformer unit comprises a switching device connected between the primary winding and the second output node, and
wherein the secondary side of the transformer unit comprises:
a secondary winding magnetically coupled with the primary winding;
a first output diode connected with one terminal of the secondary winding in a forward direction;
a second output diode connected with the first output diode in a reverse direction; and
an output inductor having one terminal connected with the first and second output diodes in the reverse direction and an opposite terminal connected with an output capacitor.

19. The single stage AC/DC converter of claim 18, wherein the primary side of the transformer unit comprises:
a first switching device and a primary-side first diode having one terminal connected with the first output node; and
a second switching device and a primary-side second diode having one terminal connected with the second output node,
wherein the primary winding has one terminal connected with opposite terminals of the first switching device and the primary-side second diode and an opposite terminal connected with opposite terminals of the second switching device and the primary-side first diode.

20. The single stage AC/DC converter of claim 18, wherein the transformer unit further comprises a reset winding and a diode connected to each other in series between the first and second output nodes, and the reset winding is connected with the diode in a reverse direction.
